(19) United States
(12) Patent Application Publication
(10) Pub. No.: US 2023/0225285 A1
(43) Pub. Date: Jul. 20, 2023

(54) VENTILATED ANIMAL CRATE

(71) Applicants: JON IRVIN LEVIN, Arcadia, FL (US); Caleb L. Cline, North Port, FL (US)

(72) Inventors: JON IRVIN LEVIN, Arcadia, FL (US); Caleb L. Cline, North Port, FL (US)

(73) Assignee: Active Air Pet Crates, LLC, Naples, FL (US)

(21) Appl. No.: 17/681,804

(22) Filed: Feb. 27, 2022

Related U.S. Application Data
(63) Continuation of application No. 16/437,000, filed on Jun. 11, 2019, now abandoned.
Application No. 16/437,000 is a continuation-in-part of application No. 16/194,305, filed on Nov. 17, 2018, now abandoned.

(51) Int. Cl. A01K 1/00

(52) U.S. Cl. CPC A01K 1/0052; A01K 1/0064

(57) ABSTRACT

A ventilated animal crate (1) having a ventilation system (15) for circulating fresh air through the animal crate to prevent pets contained within the ventilated animal crate from overheating. At least one fan (37) is mounted in a top panel (7) and /or rear panel (5) of the crate and is connected to air distribution channel (30) in the top panel having air vents (40) for widespread distribution of air inside the ventilated animal crate. The at least one fan has at least one filter (37) to remove debris from the air.

### CROSS-REFERENCE TO RELATED APPLICATIONS

This is a continuation of U.S. application Ser. No. 16/437,000, filed on Jun. 11, 2019, which was continuation-in-part application of U.S. application Ser. No. 16/194,305, filed on Nov. 17, 2018, and claims priority to U.S. application No. 62/721,002, filed on Aug. 22, 2018. The patent applications identified above are incorporated herein by reference in their entirety to provide continuity of disclosure.

### FIELD OF THE INVENTION

This invention relates to animal crates and more particularly to an animal crate having a ventilation system with at least one active fan for circulating fresh air through the animal crate to prevent pets contained within the animal crate from overheating.

### BACKGROUND OF THE INVENTION

Animal crates are commonly used to secure dogs and other animals during transport or while being left unsupervised. Animal crates may also be left open so a dog may freely enter or exit the crate to rest.

Unfortunately, overheating is a common problem when crating dogs. This is due the confined area within the crate combined with a lack of air movement. Overheating becomes even more of a problem when a crate is placed outdoors on a patio, in a cargo area of a vehicle or other space where heat is already an issue and/or air flow is at a minimum or nonexistent.

Some crates incorporate small fans in a backside of the crate, but such fans do not provide sufficient air flow to prevent a pet contained therein from overheating, particularly in a warm environment.

Therefore, a need exists for an animal crate having a ventilation system for circulating fresh air through the animal crate to prevent pets contained within the animal crate from overheating.

### SUMMARY OF THE INVENTION

The primary object of the present invention is to provide an animal crate having a ventilation system for circulating fresh air through the animal crate to prevent pets contained within the animal crate from overheating.

The present invention fulfills the above and other objects by providing an animal crate having an inner surface, outer surface, front panel, rear panel, bottom panel, top panel, right side panel and left side panel. A door is located on the front panel and hingedly attached thereto. The door is preferably a wire mesh door to allow air to pass through. The crate uses intake fans mounted on either or both the top and rear panel of the crate, which pull air into a hollow chamber within the crate. The air will collect in the chamber while the intake fans continuously push air from the hollow chamber through apertures in a false ceiling of the crate. The top panel and side panels of the crate would preferably have angled holes to better distribute air flow within the crate while preventing an animal from accessing any moving parts within the fans.

The at least one fan is preferably a rheostat fan or equivalent electric fan having a housing that contains at least one fan blade that covers the at least one active ventilation aperture the top panel and/or rear panel of the crate and forces air through the at least one active ventilation aperture and into the crate when activated by a power source.

The fans may be activated and deactivated manually by an individual directly at the crate or remotely via a handheld remote or over the Internet using a smart phone or other computer device. Alternatively, the fan may be activated and deactivated by one or more sensors, such as a weight sensor, heat sensor, motion sensor, proximity sensor and so forth, that senses if a dog is present in the crate and and/or determines a temperature or heat signature within the crate has exceeded or fell below a predetermined level.

Optionally, filters can be inserted between each fan and the crate to collect airborne pet hair and other debris.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a front view of a ventilated animal crate of the present invention;

FIG. 2 is a rear view of a ventilated animal crate of the present invention;

FIG. 3 is a side view of a ventilated animal crate of the present invention;

FIG. 4 is an exploded perspective view of the ventilated animal crate of the present invention;

FIG. 5 is a block diagram illustrating the components of a ventilation system of the present invention;

FIG. 6 is an exploded view of a filter assembly for a fan of the present invention;

FIG. 7 is a partial cutaway view of an animal crate having a rear mounted fan and false-bottom roof;

FIG. 8 is a cutaway side view of the a fan and filter setup for the animal crate shown in FIG. 7;

FIG. 9 is a partial cutaway view of an animal crate having a top mounted fan and false-bottom roof;

FIG. 10 is a cutaway side view of the a fan setup for the animal crate of the present invention;

FIG. 11 is a rear view of the animal crate with fans mounted on sides in a top rear panel of the crate;

FIG. 12 is a top view of the animal crate of FIG. 11;

FIG. 13 is a rear view of the animal crate with fans mounted on a top panel of the crate; and

FIG. 14 is a top view of the animal crate of FIG. 13.

### DESCRIPTION OF THE PREFERRED EMBODIMENTS

For purposes of describing the preferred embodiment, the terminology used in reference to the numbered accessories in the drawings is as follows:
1. ventilated animal crate, generally
2. inner surface
3. outer surface
4. front panel
5. rear panel
6. bottom panel
7. top panel
8. right side panel
9. left side panel
10. door
11. fan
12. housing
13. fan blade
14. fan vent aperture
15. ventilation system
16. power source
17. manual control
18. remote control
19. sensor
20. weight sensor
21. heat sensor
22. motion sensor
23. proximity sensor
24. filter assembly
25. filter
26. filter housing
27. filter support
28. grill
29. rear-mounted fans
30. roof air flow channels
31. rear air flow channels
32. air filters
33. air inlet
34. top-mounted fans
35. top side panel of crate
36. top air flow
37. rheostat
38. carry handle
39. locking pins
40. vents

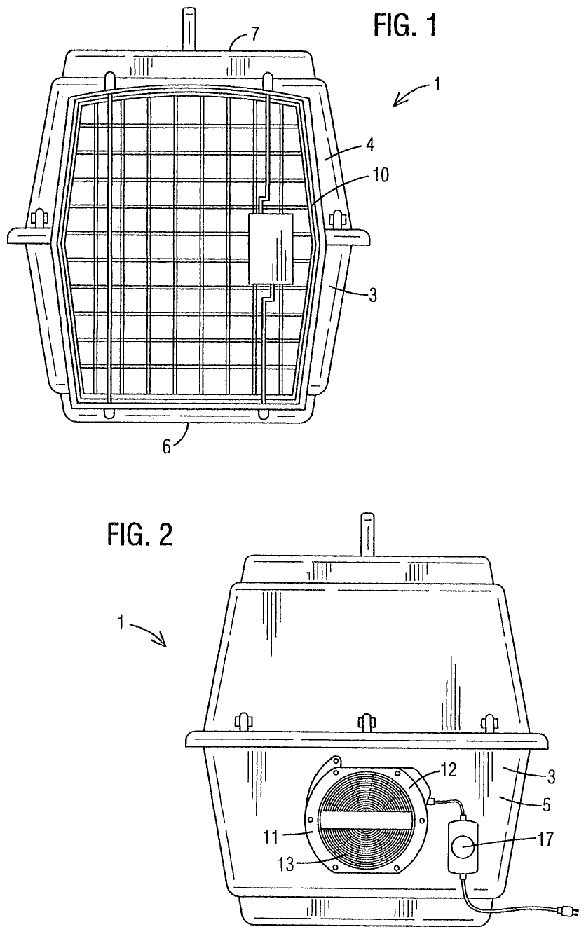

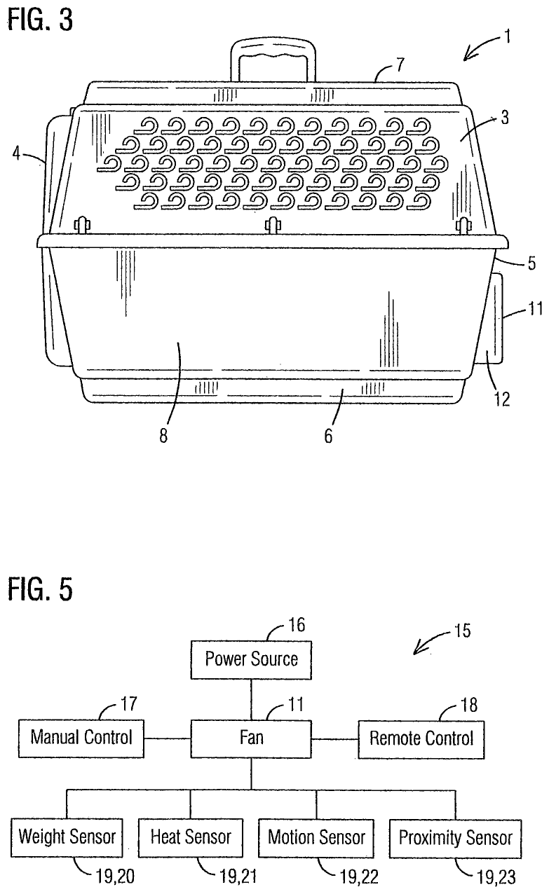

With reference to FIGS. 1-4, a front, rear view, side view and exploded perspective view, respectively, of a ventilated animal crate 1 of the present invention is illustrated. The ventilated animal crate 1 has an inner surface 2, outer surface 3, front panel 4, rear panel 5, bottom panel 6, top panel 7, right side panel 8 and left side panel 9. A door 10 is located on the front panel 4 and is hingedly attached thereto. The door 10 is preferably a wire mesh to allow air to pass through.

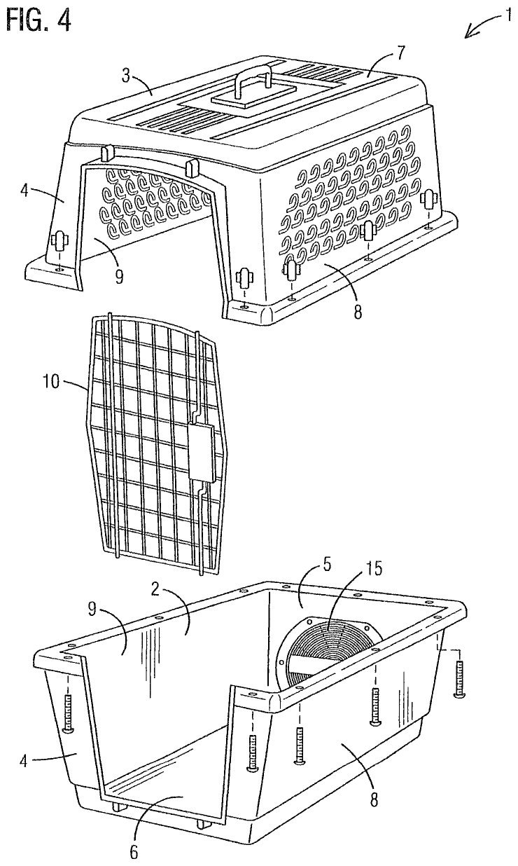

As illustrated in FIGS. 2 and 4, a fan 11 is preferably located on the rear panel 5 of the ventilated animal crate 1 and is mounted to the outer surface 3 of the rear panel 5. The fan 11 is preferably a rheostat fan or equivalent electric fan having a housing 12 that contains at least one fan blade 13. The rear panel 5 is preferably a rigid panel to provide a stable surface for mounting the fan 11. A plurality of fan vent apertures 14 are located on the rear panel 5 clustered around a central point so that the entire plurality of fan vent apertures 6 are located within the housing 12 parallel to the fan blade 13 to allow air to pass from the fan 11 and into the ventilated animal crate 1. The plurality of fan vent apertures 6 are each preferably substantially circular-shaped to prevent an animals tongue or other body part from passing through. The plurality of fan vent apertures 6 in combination with the rigid rear panel 5 create a rigid barrier that prevents an animal from accessing the fan blade 13 as would be possible with a conventional grate style fan cover.

With reference to FIG. 5, a block diagram illustrating the components of a ventilation system 15 of the ventilated animal crate 1 of present invention is illustrated. The fan 11 is connected to at least one power source 16, which may be a wall outlet, one or more batteries, vehicle outlet and so forth. The fan 11 may be activated and deactivated manually by an individual directly via at least one manual control 17 located on the ventilated animal crate 1 or remotely via a remote control 18, such as a handheld remote or via the Internet using an electronic device, such as a computer, smart phone, tablet and so forth.

Alternatively, the fan 11 may be activated and deactivated by one or more sensors 19 in communication with the fan 11, such as a weight sensor 20, heat sensor 21, motion sensor 22, proximity sensor 23 and so forth, each of which detects if a dog is present in the ventilated animal crate 1 and/or determines a temperature or heat signature within the ventilated animal crate 1 has exceeded or has fallen below a predetermined level.

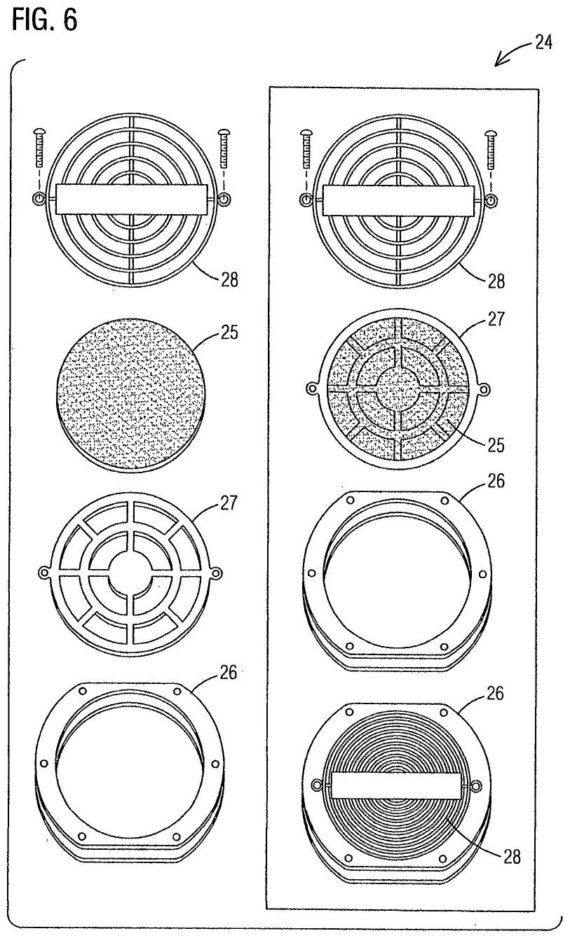

With reference to FIG. 6, an exploded view of a filter assembly 24 for a fan 11 of the present invention is illustrated. The filter assembly 24 comprises a filter 25 that is secured to the fan by a housing 26. A rigid support 27 keeps the filter 25 in a fixed position within the housing 26 and a grill 28 covers the filter 25 and fan 11.

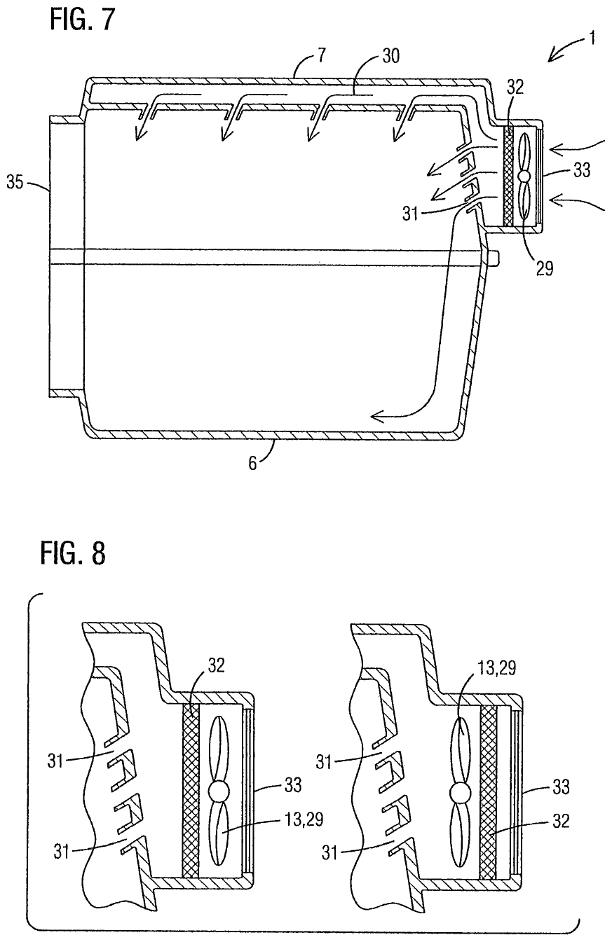

FIG. 7 illustrates an animal crate 1 with rear-mounted fans 29. This rear-mounted fan version has a top panel 7 with a false-bottom roof 30 having internal air flow channels 30 to better distribute fan-driven air to the animal within the crate. In addition, the housing for the rear-mounted fan 29 contains slanted vent air flow channels 31 to better direct air into the crate. The air flow channels 30 and 31 may be lined with self-cooling plastic to help maintain the temperature within the crate.

FIG. 8 illustrates a side closeup view of the rear-mounted fans 29 with filters 32 on either the outside or inside the fan blade 13. The filters 32 may be made of self-cooling plastic fibers designed to remove contaminates and debris from the incoming air flow 33 before distribution through the air channels 31 and 30 within the crate.

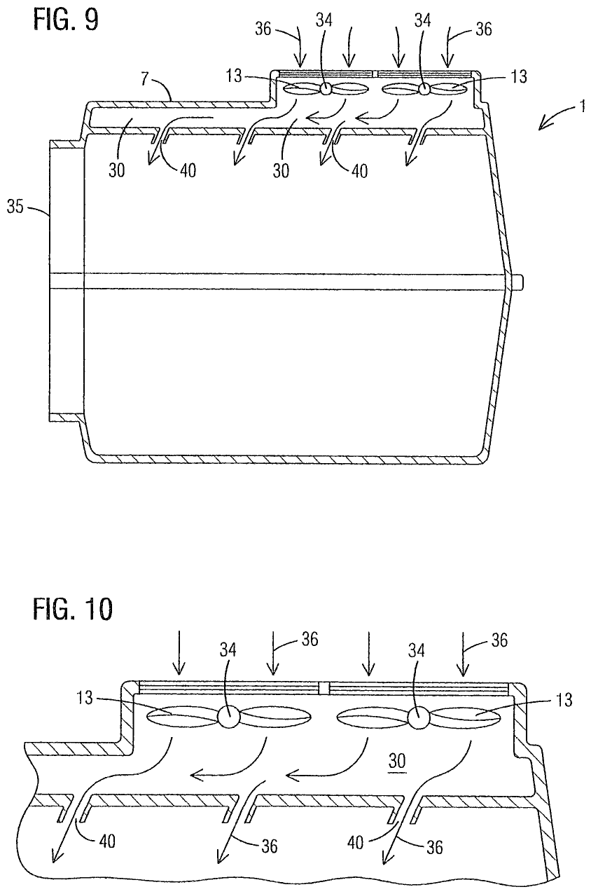

FIG. 9 illustrates a top-mounted fan version of the animal crate showing a top-mounted fans housing 34 with fan blades 13 pulling air flow 36 into the top panel 7 into air flow channels 30 and directed downward at a slant through vents in a top section 35 of the top panel 7 of the crate.

FIG. 10 illustrates in a close up side view of the top-mounted fans 34 of the animal crate of FIG. 9 with fan blades 13 which pull ambient air 36 into the crate.

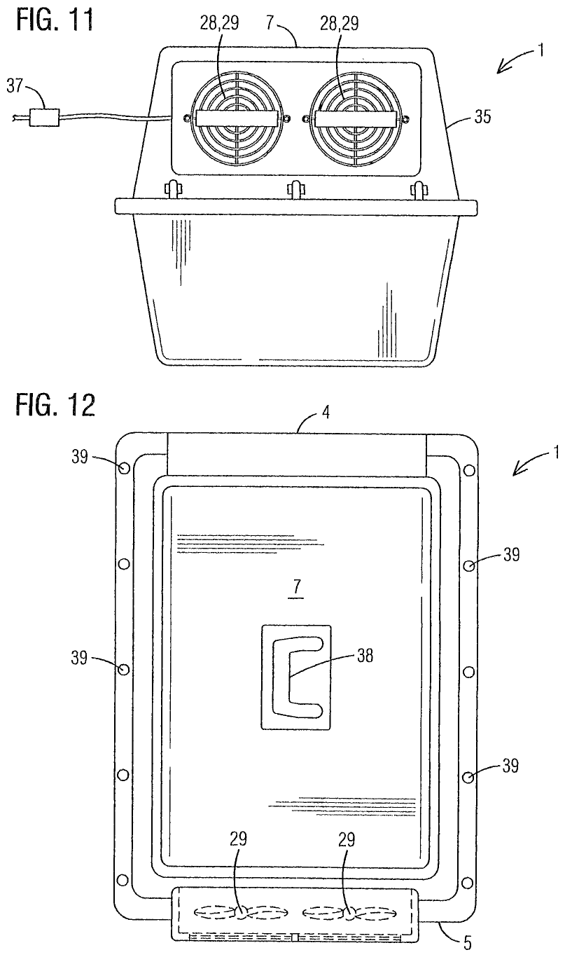

FIGS. 11 and 12 illustrate the rear mounted-fan version showing the side-mounted fans 29 in the upper section 35 of the top panel 7 which are electrically connected to a rheostat 37 for temperature setting and control to activate the fans when necessary to maintain air temperature at a desired setting within the crate. In addition as shown in FIG. 12 the top panel also has a carry handle 38 and locking pins 39 which secure it to the crate but allow it to be removed as necessary.

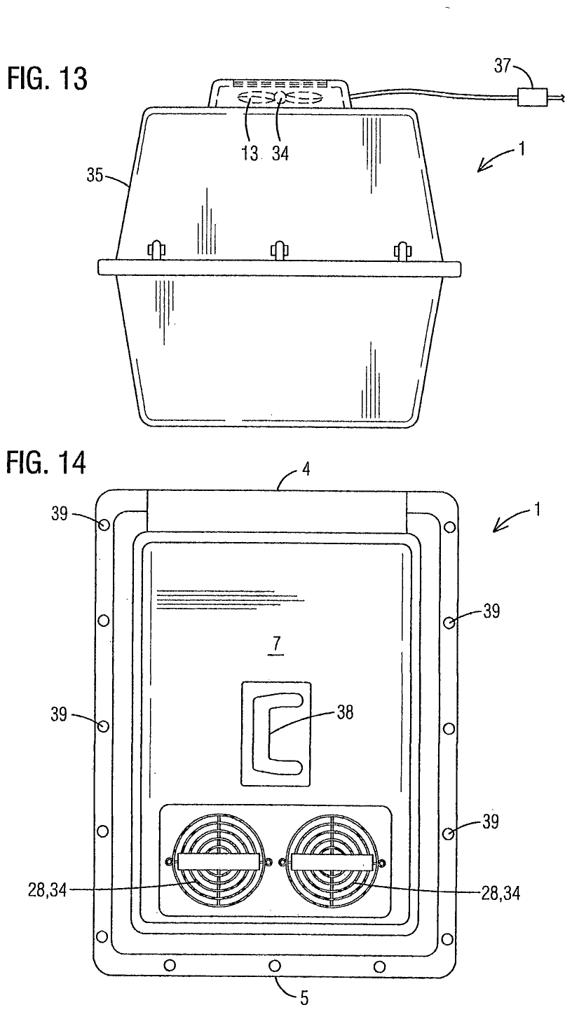

FIGS. 13 and 14 illustrate the top-mounted fan version of the animal crate with the fan blades 13 in a housing 34 electrically connected to a rheostat 34 for activating the fans 13 to maintain temperature control within the crate. FIG. 14 shows the carry handle 38 and locking pins 39 discussed above in relation to FIG. 12.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

Having thus described our invention, we claim:

1. A ventilated animal crate comprising:
an inner surface, outer surface, front panel, rear panel, bottom panel, top panel, right side panel and left side panel;
a door hingedly attached to the front panel wherein the panel is a wire mesh to allow air to pass through;
a ventilation system for circulating air through said ventilated animal crate; and
at least one fan forming part of the ventilation system mounted in a panel of the animal crate.

2. The ventilated animal crate of claim 1 wherein said ventilation system further comprises:
a top panel having an exterior top and an interior surfaces forming an air channel between said surfaces through which air from the at least one fan is distributed through a plurality of ventilation vents in the inner surface to inside the ventilated animal crate.

3. The ventilated animal crate of claim 2 wherein said ventilation system further comprises:
the at least one fan is mounted in the top panel of the ventilated animal crate.

4. The ventilated animal crate of claim 2 wherein said ventilation system further comprises:
the at least one fan is mounted in the rear panel of the ventilated animal crate.

5. The ventilated animal crate of claim 2 wherein said ventilation system further comprises:
at least one fan mounted in the top panel and at least one fan mounted in the rear panel of the ventilated animal crate.

6. The ventilated animal crate of claim 4 wherein said ventilation system further comprises:
the at least one fan is mounted in housing in the rear panel, said housing having an air channel connected to the air channel in the top panel of the ventilated animal crate.

7. The ventilated animal crate of claim 2 wherein said ventilation system further comprises:
at least one filter in the at least one fan of the ventilated animal crate.

8. The ventilated animal crate of claim 6 wherein said ventilation system further comprises:
a plurality of angled air flow directional slots in the housing between the at least one fan and an interior of the ventilated animal crate.

9. The ventilated animal crate of claim 1 wherein said ventilation system comprises at least one manual control in communication with said fan.

10. The ventilated animal crate of claim 1 wherein:
said ventilation system further comprises at least one remote control in communication with said at least one fan.

11. The ventilated animal crate of claim 1 wherein:
said ventilation system further comprises at least one sensor for detecting if an animal is present in the ventilated animal crate; and
said at least one sensor being in communication with said at least one fan.

12. The ventilated animal crate of claim 1 wherein:
said ventilation system further comprises at least one weight sensor for detecting if an animal is present in the ventilated animal crate; and
said at least one weight sensor being in communication with said at least one fan.

13. The ventilated animal crate of claim 1 wherein:
said ventilation system further comprises at least one motion sensor for detecting if an animal is present in the ventilated animal crate; and
said at least one motion sensor being in communication with said at least one fan.

14. The ventilated animal crate of claim 1 wherein:
said ventilation system further comprises at least one proximity sensor for detecting if an animal is present in the ventilated animal crate; and
said at least one proximity sensor being in communication with said at least one fan.

15. The ventilated animal crate of claim 1 wherein:
the at least one fan is mounted on the rear panel and the plurality of fan vent apertures are located on the rear panel clustered around a central point so that the plurality of fan vent apertures are located parallel to the fan blade to allow air to pass from the at least one fan and into the ventilated animal crate.

16. The ventilated animal crate of claim 1 wherein:
said plurality of fan vent apertures are each preferably substantially circular-shaped to prevent an animals tongue or other body part from passing through;
animal from accessing a fan blade located within the fan; and
said plurality of fan vent apertures are each preferably substantially circular-shaped to prevent an animals tongue or other body part from passing through.
